(19) United States
(12) Patent Application Publication
(10) Pub. No.: US 2020/0043018 A1
(43) Pub. Date: Feb. 6, 2020

(54) INTELLIGENT DATA SHARING

(71) Applicant: Capital One Services, LLC, McLean, VA (US)

(72) Inventors: Michael MOSSOBA, Arlington, VA (US); Joshua EDWARDS, Philadelphia, PA (US); Abdelkadar M'Hamed BENKREIRA, Washington, DC (US)

(21) Appl. No.: 16/053,431

(22) Filed: Aug. 2, 2018

(51) Int. Cl. G06Q 30/02

(52) U.S. Cl. CPC G06Q 30/0201; G06Q 20/352; G06Q 30/0236

(57) ABSTRACT

A device receives, in real-time, a request to share data. The request includes an account identifier and a merchant identifier. The device obtains transaction data associated with the account identifier included in the request, and obtains merchant attributes associated with the merchant identifier included in the request. The device determines, using a first model, a plurality of first scores for a plurality of transaction records included in the transaction data, based on the merchant attributes, where the plurality of first scores predict a measure of relevancy of the plurality of transaction records to the merchant identifier. The device identifies at least one relevant transaction record of the plurality of transaction records based on the plurality of first scores, and transmits the at least one relevant transaction record to cause an action to be performed.

### BACKGROUND

Near field communication (NFC) is a way to communicate data at close range by way of radio waves. NFC-enabled devices, such as smart phones, may be used to conduct payments, purchase tickets, present boarding passes, and/or the like, upon being interfaced with an NFC reader. NFC-enabled devices may also obtain coupons, launch audio clips, launch video clips, and/or the like, upon being interfaced with an NFC tag on a smart poster or display.

### SUMMARY

According to some possible implementations, a method may include receiving, by a processor and in real-time, a request to share data, wherein the request includes an account identifier, and a merchant identifier. The method may include obtaining, by the processor, transaction data associated with the account identifier included in the request, and obtaining, by the processor, merchant attributes associated with the merchant identifier included in the request. The method may include determining, by the processor, and, using a first model, a plurality of first scores for a plurality of transaction records included in the transaction data, based on the merchant attributes, wherein the plurality of first scores predict a measure of relevancy of the plurality of transaction records to the merchant identifier. The method may include identifying, by the processor, at least one relevant transaction record of the plurality of transaction records based on the plurality of first scores, and transmitting, by the processor, the at least one relevant transaction record to cause an action to be performed.

According to some possible implementations, a device may include one or more memories, and one or more processors, communicatively coupled to the one or more memories, to receive, in real-time, a request to share data, wherein the request includes an account identifier, and a merchant identifier. The one or more processors may obtain transaction data associated with the account identifier included in the request, may obtain non-transaction data associated with the account identifier included in the request, and may obtain merchant attributes associated with the merchant identifier included in the request. The one or more processors may determine, using a first model, a plurality of first scores for a plurality of transaction records included in the transaction data, based on the merchant attributes, wherein the plurality of first scores predict a first measure of relevancy of the plurality of transaction records to the merchant identifier based on the merchant attributes. The one or more processors may determine, using a second model, a plurality of second scores for a plurality of non-transaction records included in the non-transaction data, based on the merchant attributes, wherein the plurality of second scores predict a second measure of relevancy of the plurality of non-transaction records to the merchant identifier based on the merchant attributes. The one or more processors may identify at least one relevant transaction record of the plurality of transaction records based on the plurality of first scores, may identify at least one relevant non-transaction record of the plurality of non-transaction records based on the plurality of second scores, and may transmit the at least one relevant transaction record and the at least one relevant non-transaction record to cause an action to be performed.

According to some possible implementations, a non-transitory computer-readable medium may store instructions that include one or more instructions that, when executed by one or more processors of a device, cause the one or more processors to receive, in real-time, a request to share data, wherein the request includes an account identifier, and a merchant identifier. The one or more instructions may cause the one or more processors to obtain transaction data associated with the account identifier included in the request, and to obtain merchant attributes associated with the merchant identifier included in the request. The one or more instructions may cause the one or more processors to determine, using a first model, a plurality of first scores for a plurality of transaction records included in the transaction data, based on the merchant attributes, wherein the plurality of first scores predict a measure of relevancy of the plurality of transaction records to the merchant identifier. The one or more instructions may cause the one or more processors to identify a plurality of relevant transaction records based on the plurality of first scores, to generate a monetary figure based on information contained in the plurality of relevant transactions records, and to transmit the monetary figure to cause an action to be performed.

### BRIEF DESCRIPTION OF THE DRAWINGS

FIGS. 1A-1C are diagrams of an example implementation described herein.

FIG. 2 is a diagram of an example environment in which systems and/or methods, described herein, may be implemented.

FIG. 3 is a diagram of example components of one or more devices of FIG. 2.

FIG. 4 is a flow chart of an example process for intelligent sharing of transaction data.

FIG. 5 is a flow chart of an example process for intelligent sharing of transaction data.

FIG. 6 is a flow chart of an example process for intelligent sharing of transaction data.

### DETAILED DESCRIPTION

The following detailed description of example implementations refers to the accompanying drawings. The same reference numbers in different drawings may identify the same or similar elements.

E-commerce businesses can employ web cookies, or other online mechanisms, to obtain information about potential customers, and use the information to tailor and/or enhance the potential customers' shopping experiences. For example, an e-commerce business may obtain information associated with the goods being viewed by a potential customer while visiting the e-commerce business's website, and use the information to automatically suggest other goods on the website that the potential customer may be interested in purchasing. Similarly, the e-commerce business may, using an online mechanism, instantly recall information about the potential customer's past spending habits while visiting the website, and reward the potential customer with a coupon or discount that is redeemable during the potential customer's current Internet session with the e-commerce business. Brick-and-mortar businesses, however, lack intelligent, efficient methods of obtaining relevant information about a potential customer during the potential customer's in-person visit.

Some implementations described herein provide an intelligence platform, by which a user may opt-in to share data (e.g., transaction data, non-transaction data, etc.) with a merchant during an in-person visit to the merchant's business, to improve the user's in-person retail experience. The user may opt-in to sharing such data using a respective payment device, such as an NFC-enabled payment device, a payment card, and/or the like. The intelligence platform may obtain the data associated with the user, and intelligently determine which data records included in the data may be relevant to the merchant, for sharing with the merchant to improve the user's in-person visit.

For example, the intelligence platform may employ a model to determine a plurality of scores for a plurality of transaction records included in transaction data associated with a user, and identify relevant transaction records to share with the merchant, based on the scores. The scores may predict a measure of relevancy of the plurality of transaction records to the merchant identifier. The merchant may obtain the relevant transaction records and tailor the user's experience during the user's in-person visit, for example, by presenting specific goods to the user, by offering the user a reward, by increasing a level of service provided to the user, and/or the like. In this way, the intelligence platform may automate the generation and/or transmission of relevant data to the merchant, thus, conserving resources that would otherwise be needed to manually generate such relevant data. In this way, the provision of relevant data to the merchant may be more automated, efficient, and meaningful.

In this way, several different stages of the process for sharing data are automated, which may remove human subjectivity and waste from the process, and which may improve speed and efficiency of the process and conserve computing resources (e.g., processor resources, memory resources, and/or the like). Furthermore, implementations described herein use a rigorous, computerized process to perform tasks or roles that were not previously performed or were previously performed using subjective human intuition or input. For example, currently there does not exist a technique to interface a payment device to automatically share intelligently procured transaction and/or non-transition with a merchant. Finally, automating the process for sharing data conserves computing resources (e.g., processor resources, memory resources, and/or the like) that would otherwise be wasted in attempting to determine relevant data to share with the merchant.

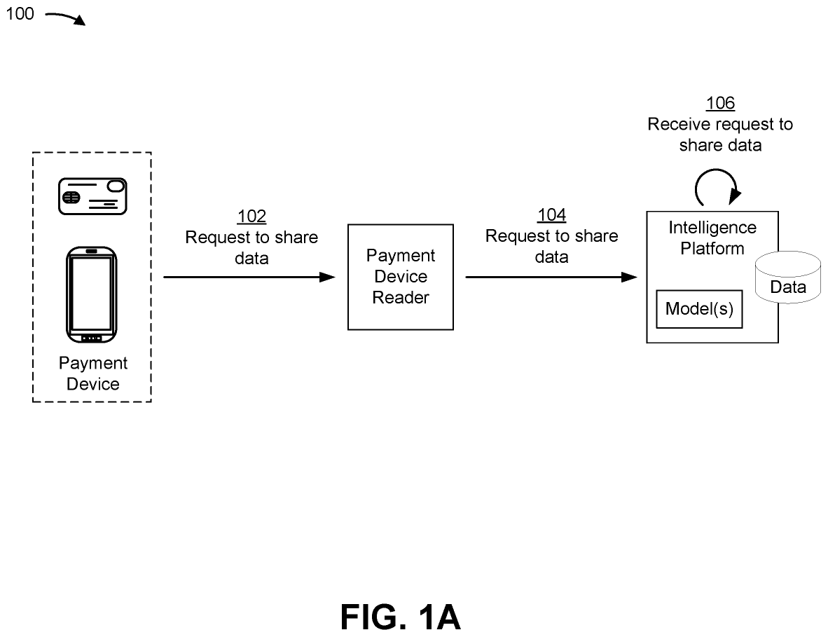

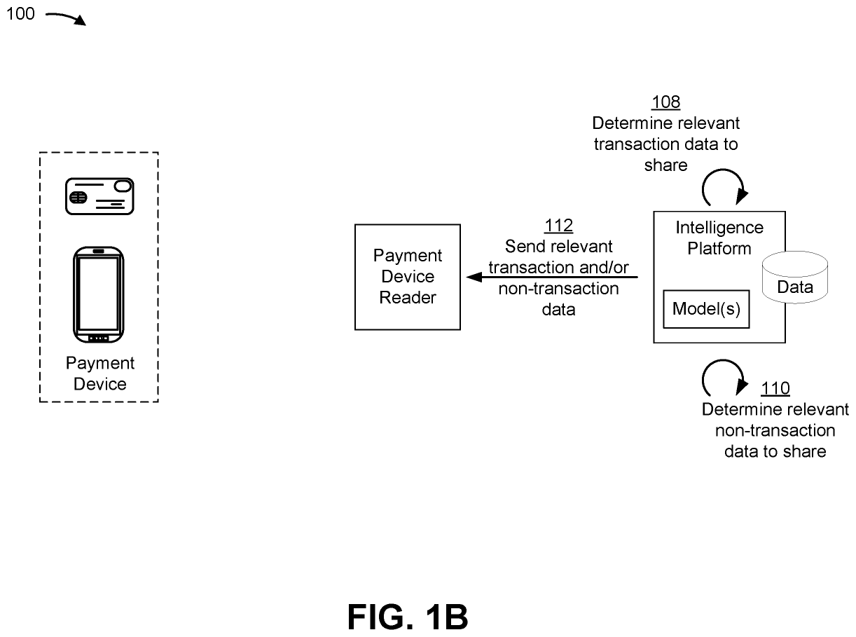

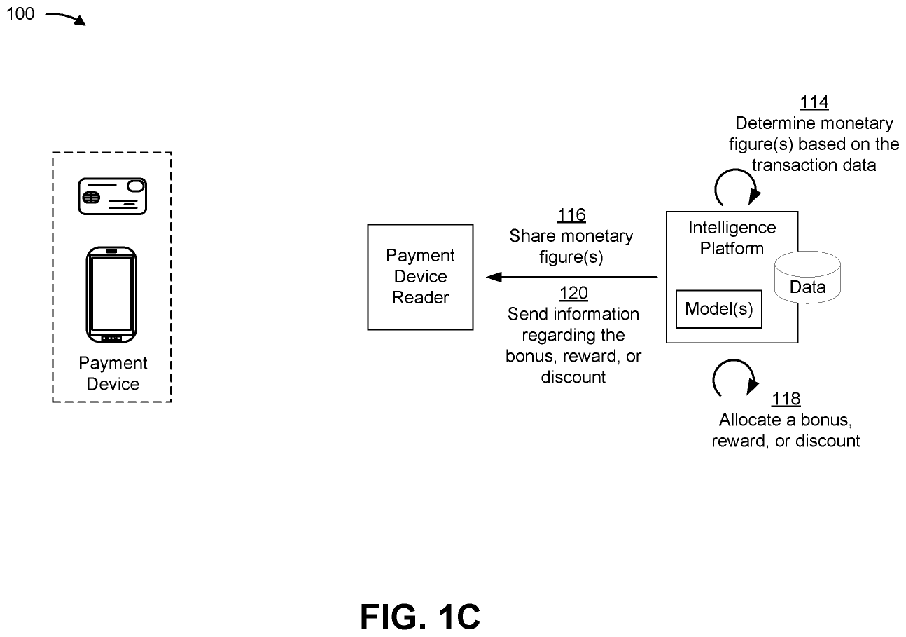

FIGS. 1A-1C are diagrams of an example implementation 100 described herein. As shown in FIGS. 1A-1C, example implementation 100 may include an intelligence platform that interacts with one or more payment devices and/or with one or more payment device readers.

As shown in FIG. 1A, and by reference number 102, a user may employ a payment device to generate and send a request to share data with a merchant. In some implementations, the payment device may include, for example, a transaction card (e.g., a payment card, a credit card, a debit card, etc.), a mobile device storing a transaction card, an NFC-enabled device (e.g., an NFC-enabled transaction card, an NFC-enabled device storing a transaction card, etc.), and/or the like. In some implementations, the payment device may communicate the request to share data to the payment device reader.

In some implementations, the request to share data may include an account identifier associated with the payment device, a transaction card identifier of a transaction card stored on the payment device, a user identifier of the user of the payment device, and/or the like, which the intelligence platform may use to obtain data to share with the merchant. For example, and, as described further herein, the intelligence platform may obtain data associated with the payment device and/or the user of the payment device based on obtaining data records (e.g., transaction records, non-transaction records, etc.) that include and/or are otherwise associated with the account identifier. The account identifier may include, for example, and without limitation, an account number associated with the payment device (e.g., a bank account number, a credit card number, a debit card number, etc.), an identifier associated with the payment device (e.g., a phone number, a transaction card number for a transaction card stored on the payment device), and/or the like.

In some implementations, the user may utilize an existing payment device to initiate the request to share data with the merchant, by way of interfacing the existing payment device with the payment device reader. In this way, the need to generate, store, and/or carry additional cards, devices, and/or anything other than the payment device, to initiate requests to share data, is obviated. For example, in some implementations, a user may enter a brick-and-mortar merchant establishment and interface a payment device, with a payment device reader located in the merchant establishment, to initiate the request to share data with the merchant. In some implementations, the payment device may be interfaced with the payment device reader by way of swiping the payment device relative to the payment device reader, inserting the payment device in a portion of the payment device reader, tapping the payment device to the payment device reader, touching the payment device to the payment device reader, bringing the payment device within a threshold distance of the payment device reader, and/or the like. As an example, the request to share data with the merchant may be communicated by way of a contactless communication between an NFC-enabled payment device and an NFC reader.

As further shown in FIG. 1A, and by reference number 104, the payment device reader may communicate the request to share data to the intelligence platform. In some implementations, the request may be communicated by way of transmitting one or more signal communications across a communication network established between the payment device reader and the intelligence platform. For example, the payment device reader may obtain the request to share data from the payment device, and communicate the request to share data to the intelligence platform by way of a cellular network, the Internet, and/or the like.

In some implementations, the request to share data communicated by the payment device reader includes the account identifier and a merchant identifier. The merchant identifier may include an identifier associated with the merchant (e.g., a merchant name, a merchant identification number, a merchant account identification number, etc.), an identifier associated with the payment device reader provided by the merchant (e.g., a terminal identification number, etc.), an identifier associated with the network employed by the merchant (e.g., a gateway identification number, etc.), and/or the like, for use in identifying the merchant. In some implementations, the request to share data may include multiple merchant identifiers, which the intelligence platform may use to identify a specific merchant operating at a physical location corresponding to the location of where request to share data was initiated.

In some implementations, the request to share data may further include, as an option, timestamp information, location information, and/or the like, which the intelligence platform may use to authenticate and/or authorize the request to share data, in addition to one or more other factors. For example, where a location and/or time zone of the request to share data does not correspond to a typical location and/or time zone of the user, the request to share data may be denied. In this way, the security associated with sharing data may improve.

In some implementations, the payment device reader may include a standalone device provided in a merchant location. For example, the payment device reader may include a point-of-sale (POS) device, a kiosk, a terminal, an NFC reader, and/or the like, located in the merchant location. As another example, the payment device reader may include a smart poster, a smart device, and/or the like, provided in the merchant location, by which the user may receive and/or review instructions for opting-in to share data with the merchant. As described further herein, in some implementations, the merchant may offer the user a reward (e.g., a discount, bonus, coupon, or promotional item) for opting-in to sharing data, which may increase participation.

As further shown in FIG. 1A, and by reference number 106, the intelligence platform may receive the request to share data from the payment device reader. The request received by the intelligence platform may include the account identifier and one or more merchant identifiers. As described further herein, the intelligence platform may, using the account identifier, obtain data associated with the account identifier and intelligently determine which records associated with the data to share with the merchant based on determining the relevancy of the data to the merchant. In this way, only a subset of the data (i.e., relevant records) associated with the account identifier may be shared with the merchant. In this way, computing resources (e.g., processing resources, memory resources, etc.) and network resources that would otherwise be needed to manually determine and obtain relevant data may be conserved.

Turning now to FIG. 1B, and as shown by reference number 108, the intelligence platform may determine relevant transaction data to share with the merchant. In some implementations, the transaction data may include a plurality of transaction records. The transaction records may include, for example, and without limitation, transaction data that may indicate a date of a transaction, a merchant identifier associated with a transaction, a total amount of a transaction, an amount of gratuity (i.e., a tipped amount) associated with a transaction, item level data, combinations thereof, and/or the like. Item level data may include, for example, and without limitation, data indicating an item that was purchased (e.g., a coffee, a doughnut, a shirt, a dog toy, a computer, a phone, etc.), data indicating a specific service that was purchased (e.g., a haircut, a deluxe pedicure, a hot-stone massage, an eyebrow wax, etc.), data indicating a price of the item or service that was purchased, data indicating a general size of the item that was purchased (e.g., small, medium, large, etc.), data indicating a duration of the service that was purchased (e.g., 60 minutes, a subscription renewal period, etc.), data indicating a specific size of the item that was purchased (e.g., 36″ waist, 36″ length, a shoe size, a size 8 dress, a 42″ screen size, etc.), and/or the like. The intelligence platform is configured to review all, or a portion (e.g., data within the last 12 months, the last 6 months, etc.), of the aggregate transaction data associated with the account identifier, and intelligently determine relevant transaction records to share with the merchant.

In determining the relevant transaction records to share with the merchant, the intelligence platform may access one or more data models, one or more machine learning models, one or more rules, and/or logic, whereby the intelligence platform may assess the relevancy of transaction records included in transaction data, to the merchant identifier, based on merchant attributes associated with the merchant identifier. For example, the intelligence platform may receive the request to share data, obtain transaction data associated with the account identifier included in the request to share data, and obtain merchant attributes associated with the merchant identifier, by which the intelligence platform may determine relevant transaction data to share with the merchant. The relevant transaction data may be determined, at least in part, by using a model that inputs the merchant attributes obtained for and/or associated with the merchant identifier, and outputs scores for transaction records included in the transaction data, based on a degree of relevancy of the transaction records to the merchant attributes. The scores may indicate a level of confidence that a transaction record may be of relevance to a merchant, for example, in providing an increased level of service to the user. Scores that satisfy a threshold may be identified, aggregated, and shared with the merchant, by way of the payment device reader and/or another merchant device located in the merchant establishment.

Examples of relevant transaction records may include, for example, transaction records that indicate a total amount of goods or services purchased by the user from a merchant's competitor, a number of times the user has visited the merchant's competitor in the past (e.g., in the past 6-months, 12-months, etc.), a size of an item purchased from the merchant, a type of service purchased from the merchant, an amount of gratuity provided to the merchant for a previous transaction, and/or the like. Such records may be of relevance to the merchant, for example, by providing the merchant real-time insight into the user's spending habits and/or preferences during the user's in-person visit, which present opportunities for the merchant to better serve the user, suggest items sized to fit the user, allow the user to advance more quickly in a waiting line, gain priority over other users, or generally increase a level of service provided to the user. In this way, the user may increase expenditures with and/or loyalty towards the merchant.

In some implementations, the merchant attributes being input into one or more models, by the intelligence platform, may include, for example, and without limitation, descriptors of the type or category of the merchant (e.g., a clothing store, a restaurant, a salon, a computer store, etc.), descriptors of the goods and/or services provided by the merchant, descriptors of the merchant's competitors, descriptors of the merchant's geographic location (e.g., a zip code, GPS coordinates, a time zone, etc.), and/or the like. Merchant attributes may, in some implementations, include metadata that is mapped to the merchant identifier, for retrieval by the intelligence platform, upon receiving a request to share data with the merchant having the merchant identifier. The merchant attributes may be defined by a programmer of the intelligence platform, the merchant, and/or a third-party. In some implementations, the merchant attributes may be stored by the intelligence platform and/or by a computing resource associated with the intelligence platform. Additionally, or alternatively, the merchant attributes may be stored by a third-party entity (e.g., a third-party server device, etc.), that is assessible to the intelligence platform by way of sending a request, an API call, subscribing to receive the data, and/or the like.

In some implementations, the intelligence platform may perform a training operation when generating the model to determine relevant records to share with a merchant, based on the merchant attributes. For example, the intelligence platform may parse natural language descriptors of the merchant attributes, and portion the data into a training set, a validation set, a test set, and/or the like. In some implementations, intelligence platform may train the model to determine relevant records based on the merchant attributes using, for example, an unsupervised training procedure based on the training set of the data. For example, intelligence platform may perform dimensionality reduction to reduce the merchant attributes to a minimum feature set, thereby reducing an amount of processing required to train the model to determine the relevant data, and may apply a classification technique, to the minimum feature set. The intelligence platform may generate trained models using the minimum feature set to generate models based on thousands or millions of merchant attributes for determining the relevancy of thousands or millions of data records, thereby increasing an accuracy and consistency of the models. In this way, intelligence platform may analyze thousands, millions, or billions of data records for machine learning and model generation—a data set that cannot be processed objectively by a human actor.

As an example, the merchant identifier may include an identifier for a specific McDonalds®. The merchant attributes associated with the specific McDonalds® may include, for example, keyword descriptors associated with the merchant category associated with the specific McDonalds® (e.g., “fast-food”, “restaurant”, etc.), keyword descriptors that indicate or identify the type of goods or services offered by the specific McDonalds® (e.g., “food”, “hamburger”, “French fries”, “milkshakes”, etc.), descriptors that indicate or identify competitors of the specific McDonalds® (e.g., an identifier for specific Burger King®, an identifier for a specific Wendy's®, etc.), keyword descriptors that indicate or identify the geographic location of the specific McDonalds®, and/or the like. The intelligence platform may obtain the merchant attributes associated with the specific McDonalds® to intelligently determine relevant transaction data to share with the merchant, by way of a model, and/or the like. The intelligence platform may determine, based on a score output by the model, whether a transaction record is relevant. The intelligence platform may cause one or more actions to be performed based on whether the transaction record is relevant. Such actions may include, for example, transmitting the relevant transaction record to the merchant, increasing a level of service provided to a user, offering a reward to the user, and/or the like.

As an example, the models implemented by the intelligence platform may receive, as input, the merchant attributes for a merchant identifier, and predict whether a transaction record is likely to be relevant to the merchant associated with the merchant identifier, based on a score output by the data model or the machine learning model. Where the score is low, the intelligence platform may determine that the transaction record is not as relevant to the merchant, and the intelligence platform may decide not to share the transaction record with the merchant. For example, transaction data associated with a purchase, by a user, of baked goods at a merchant bakery may not be deemed relevant to and/or shared with a merchant that sells computers. Where the score is high, the intelligence platform may determine that the transaction record is relevant to the merchant, and the intelligence platform may decide to share the transaction record with the merchant. In this case, the transaction data associated with the purchase at the merchant bakery may be deemed relevant to and/or shared with a competitor of the merchant bakery, a merchant that sells coffee, and/or possibly even merchants that sell dietary supplements and/or athletic equipment. In this way, the analysis of transaction data obtained by the intelligence platform may be more automated, efficient, and consistent. Further, the amount of computing resources needed to manually analyze the transaction data for determining relevant data may be obviated or reduced. The transaction data may be analyzed alone, or, in combination with non-transaction data as described herein.

As further shown in FIG. 1B, and by reference number 110, the intelligence platform may determine relevant non-transaction data to share with the merchant. The non-transaction data may include, for example, and without limitation, data associated with a user of an account identified by the account identifier, or data associated with the account identified by the account identifier. In some implementations, the non-transaction data may include a plurality of non-transaction records.

Briefly, the non-transaction records may include, for example, records indicating a personal attribute associated with the user (e.g., demographic information, a level of income, a food allergy, an occupation, a hobby, a descriptor of at least one family member, a shoe size, a waist size, a height, etc.), records indicating a user preference (e.g., a user's preferred color, preferred clothing type, preferred clothing style, preferred food, preferred beverage, preferences regarding one or more goods (e.g., preference for organic goods versus non-organic goods), preference regarding one or more services (e.g., preference for a deep tissue massage versus a Swedish massage), etc.), records indicating a credit score associated with the user, records indicating a credit limit associated with the account, records indicating an amount of available credit associated with the account, records indicating a tier level associated with the account (e.g., silver, gold, etc.), records indicating an available balance associated with the account, records indicating an account status (e.g., whether the account is closed, overdrawn, in good standing, in collections, etc.), records associated with the user's social media accounts, records associated with the user's location, and/or the like. The intelligence platform is configured to review all, or a portion of the aggregate non-transaction data associated with the account identifier, and intelligently determine relevant non-transaction records to share with the merchant.

In determining the relevant non-transaction records to share with the merchant, the intelligence platform may access one or more data models, one or more machine learning models, one or more rules, and/or logic, whereby the intelligence platform may assess the relevancy of non-transaction records included in the non-transaction data, to the merchant identifier, based on merchant attributes associated with the merchant identifier. For example, the intelligence platform may receive the request to share data, obtain non-transaction data associated with the account identifier included in the request to share data, obtain merchant attributes associated with the merchant identifier, and execute a model that inputs the merchant attributes to determine scores for the non-transaction data. The scores may indicate a level of confidence that a non-transaction record included in the non-transaction data may be of relevance to the merchant, for example, so that the merchant may provide an increased level of service to the user. Scores that satisfy a threshold may be identified, aggregated, and transmitted to the merchant, by way of the payment device reader and/or other merchant device.

Examples of relevant non-transaction records may include, for example, records that indicate the user's food allergies to a merchant restaurant, records that indicate the user's beverage preferences to a coffee or wine merchant, the user's occupation to a clothing retailer, and/or the like. Such records may be of relevance to the merchant, for example, by providing the merchant real-time insight into the user's persona and/or preferences during the user's in-person visit, which present opportunities for the merchant to better serve the user, suggest food, beverage, and/or clothing items to the user, or generally increase a level of service provided to the user. In some implementations, the non-transaction data may be provided to the intelligence platform by the user, by a financial entity with which the user has established an account and has opted-in to allow the financial entity to share data, or a third-party. The non-transaction data may be stored by the intelligence platform and/or by a computing resource associated with the intelligence platform. Additionally, or alternatively, the non-transaction data may be stored by a third-party entity (e.g., a third-party server device, etc.), that is assessible to the intelligence platform by way of a request, an API call, and/or the like.

In some implementations, the intelligence platform may obtain the merchant attributes associated with the merchant to intelligently determine relevant non-transaction data to share with the merchant, by way of a model, and/or the like. The intelligence platform may determine, based on the scores output by the model, whether a non-transaction record is relevant. The intelligence platform may cause one or more actions to be performed based on whether the non-transaction record is relevant. Such actions may include, for example, transmitting the non-transaction record to the merchant, increasing a level of service provided to a user, offering a reward to the user, and/or the like.

As an example, the data model or the machine learning model may receive, as input, merchant attributes for a merchant identifier, and predict whether a non-transaction record is likely to be relevant to the merchant associated with the merchant identifier, based on the score output by the data model or the machine learning model. Where the score is low, the intelligence platform may determine that the non-transaction record is not as relevant to the merchant, and the intelligence platform may decide not to share the non-transaction record with the merchant. For example, non-transaction data associated with a user's preferred color may not be deemed relevant to and/or shared with a merchant restaurant. Where the score is high, the intelligence platform may determine that the non-transaction record is relevant to the merchant, and the intelligence platform may decide to share the non-transaction record with the merchant. In this case, the non-transaction data associated with the user's preferred color may be deemed relevant to and/or shared with a clothing merchant, an interior decorating service, and/or the like. In this way, the analysis of non-transaction data obtained by the intelligence platform may be more automated, efficient, and consistent. Further, the amount of computing resources needed to manually analyze the non-transaction data for determining relevant data may be obviated or reduced. The non-transaction data may be analyzed alone, or, in combination with transaction data. In this way, the intelligence platform may receive and analyze thousands, millions, billions, etc., of transaction records and/or non-transaction records, the volume of which cannot be processed objectively by human actors.

In some implementations, and, as an option, a user may be able to specify what data to share and/or not share with a merchant. For example, the user may instruct the intelligence platform, using a user-interface of and/or web-access to the intelligence platform, to share or not share the user's size related data, account-related data, and/or the like. In this way, the intelligence platform may withhold data from the merchant, according to the user's specifications and/or preferences. Similarly, in some implementations, the user may configure a user profile that instructs the intelligence platform what data to share and what data to withhold when receiving requests to share data. In this way, the user may customize which data to share with the merchant, to allow the merchant to gain insight into the user's persona without having to reveal more data than the user is comfortable with.

In some implementations, and, as an option, a merchant may additionally specify preferences for which transaction data and/or non-transaction data the merchant would like to receive, should a user opt-in to sharing such data. For example, a merchant may request to receive transaction data associated with the merchant's competitors, non-transaction data associated with the user's preferred clothing styles or types, non-transaction data associated with the user's occupation, and/or the like. In some implementations, the merchant may rank the data based on importance of the data to the merchant (e.g., a rank of 1 assigned to the least important data, a rank of 10 assigned to the most important data, etc.). The intelligence platform may filter the data based on the merchant preferences, and/or include the merchant's rankings, when determining which data to share with the merchant.

As further shown in FIG. 1B, and by reference number 112, the intelligence platform may share the relevant transaction data and/or the relevant non-transaction data with the merchant. In some implementations, the data may be sent to the payment device reader. The payment device reader may be configured to display and/or output (e.g., printing, etc.) the relevant data to the merchant. The merchant may obtain the relevant data, and dynamically tailor the user's in-person experience based on the data. For example, the merchant may offer the user complimentary products or services, offer the user a discount, or present items to the user that the merchant may determine to be of interest to the user.

Additionally, or alternatively, in some implementations, the intelligence platform may transmit the relevant data to the merchant by way of a merchant device other than the payment device reader. In some implementations, the merchant may access the relevant data by way of a web portal or user interface. For example, the merchant may download the relevant data from the intelligence platform, subscribe to receive (e.g., via streaming) the relevant data, and/or the like. In some implementations, the intelligence platform may send the relevant data to a smart device provided in the merchant location, such as a tablet, a computer, a phone, and/or the like.

Turning now to FIG. 1C, and by reference number 114, the intelligence platform may determine one or more monetary figures based on the relevant data. Such figures may include, for example, a total number of times a user visited a merchant location during a predetermined period of time (e.g., within the past 12-months, 6-months, etc.), a percentage of visits to the merchant as compared to the merchant's competitor, or vice versa, during the predetermined period of time, a total amount of money a user has expended purchasing from the merchant, or the merchant's competitor, during the predetermined period of time, and/or the like. The intelligence platform may determine the monetary figures based on adding data contained in multiple transaction records, subtracting data contained in the multiple transaction records, comparing data contained in the multiple transaction records, and/or the like.

As further shown in FIG. 1C, and by reference number 116, the intelligence platform may send the monetary figures to the merchant by way of the payment device reader, or other merchant device located at the merchant location. The merchant may obtain the monetary figures, and perform one or more actions based on obtaining the monetary figures. Such actions may include, for example, increasing the level of customer service provided to the user, rewarding the user, presenting the user with a complimentary food, beverage, or retail item, and/or the like.

As further shown in FIG. 1C, and by reference number 118, the intelligence platform may allocate a bonus, a reward, or a discount based on receiving the request to share data. In some implementations, the bonus, reward, or discount may be provided by a financial entity with which the user has established an account (e.g., a credit card provider, a bank, etc.), the merchant (e.g., using a merchant rewards program), and/or the like. The bonus, reward, or discount may be in the form of a coupon, an offer, a discount, loyalty points, bonus points, a money deposit to a financial account, and/or the like.

As further shown in FIG. 1C, and by reference number 120, the intelligence platform may provide information indicating the bonus, the reward, or the discount to the merchant, to cause an action to be performed. Such information may include, for example, the amount of the discount, the number of loyalty points, coupon details, and/or the like. The information may cause a merchant device to display the bonus, reward, or discount, cause the merchant device to print the bonus, reward or discount, cause the merchant device to transmit the bonus, reward, or discount to the payment device, cause the merchant device to apply the bonus, reward, or discount to a purchase, and/or the like. In this way, the level of service provided to the user may be improved and/or enhanced, in real-time, during the user's in-person visit to the merchant.

In some implementations, the communications between the payment device, the payment device reader, and/or the intelligence platform may be encrypted and/or encoded to increase security associated with communicating and sharing such information.

The intelligence platform described herein may intelligently determine, based on merchant attributes, which records included in transaction data and/or non-transaction data, to share with the merchant. In this way, brick-and-mortar merchants may dynamically identify a user upon the user opting-in to share data, dynamically obtain relevant data associated with the user's personal attributes, preferences, spending habits, and/or the like, which may be used to uniquely tailor, enhance, and/or improve the user's in-person experience. In this way, the intelligence platform may automate the determination and/or transmission of relevant data to the merchant, thereby, conserving resources that would otherwise be needed to manually generate the relevant data. In this way, the provision of relevant data to the merchant may be more automated, efficient, and consistent.

As indicated above, FIGS. 1A-1C are provided merely as an example. Other examples are possible and may differ from what was described with regard to FIGS. 1A-1C.

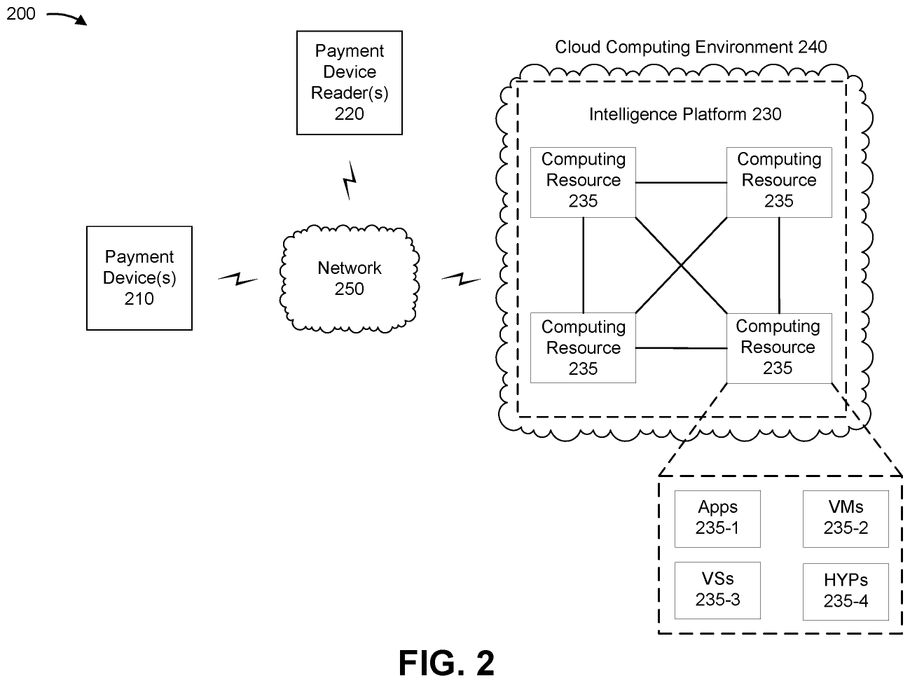

FIG. 2 is a diagram of an example environment 200 in which systems and/or methods, described herein, may be implemented. As shown in FIG. 2, environment 200 may include a payment device 210, a payment device reader 220, an intelligence platform 230, a computing resource 235, a cloud computing environment 240, and a network 250. Devices of environment 200 may interconnect via wired connections, wireless connections, or a combination of wired and wireless connections.

Payment device 210 includes one or more devices capable of sending, receiving, generating, storing, processing, and/or providing information associated with intelligently sharing transaction data and/or non-transaction data. In some implementations, payment device 210 includes a smart device, a smart phone, a computing device, a computer, a wearable computer (e.g., a smart watch, a pair of smart eyeglasses, etc.), and/or the like, having a transaction card stored thereon. In some implementations, payment device 210 may include a transaction card that can be used to complete a transaction. For example, payment device 210 may include a credit card, a debit card, a gift card, a payment card, an automated teller machine (ATM) card, a stored-value card, a fleet card, a transit card, an access card, a virtual card implemented on payment device 210, and/or the like. Payment device 210 may be capable of storing and/or communicating data for a point-of-sale (PoS) transaction with payment device reader 220. For example, payment device 210 may store and/or communicate data, such as account information (e.g., an account identifier, a cardholder identifier, etc.), expiration information of payment device 210 (e.g., information identifying an expiration month and/or year of payment device 210), banking information (e.g., a routing number of a bank, a bank identifier, etc.), transaction information (e.g., a payment token), and/or the like. For example, to store and/or communicate the data, payment device 210 may include a magnetic strip and/or an integrated circuit (IC) chip (e.g., a EUROPAY®, MASTERCARD®, VISA® (EMV) chip).

Payment device 210 may include an antenna to communicate data associated with payment device 210. The antenna may be a passive radio frequency (RF) antenna, an active RF antenna, and/or a battery-assisted RF antenna. In some implementations, payment device 210 may be a smart transaction card, capable of communicating wirelessly (e.g., via Bluetooth, Bluetooth Low Energy (BLE), near-field communication (NFC), and/or the like) with a computing device, such as payment device 210, a digital wallet, and/or another device. In some implementations, payment device 210 may communicate with payment device reader 220 to complete a transaction (e.g., based on being moved within communicative proximity of payment device reader 220), as described elsewhere herein.

Payment device reader 220 includes one or more devices capable of sending, receiving, generating, storing, processing, and/or providing information associated with intelligently sharing transaction data and/or non-transaction data. In some implementations, payment device reader 220 may include one or more devices capable of facilitating processing of a transaction associated with payment device 210. For example, payment device reader 220 may include a point-of-sale (PoS) terminal, a payment terminal (e.g., a credit card terminal, a contactless payment terminal, a mobile credit card reader, a chip reader, etc.), a security access terminal, an automated teller machine (ATM) terminal, and/or the like. In some implementations, payment device reader 220 may communicate with intelligence platform 230 to provide, to intelligence platform 230, information related to a transaction for which payment device 210 is being used, as described elsewhere herein and/or to obtain, from intelligence platform 230, information associated with the payment device and/or the user of the payment device.

In some implementations, payment device reader 220 may include one or more input components and/or output components to facilitate obtaining information from payment device 210 (e.g., an account number of an account associated with payment device 210, an expiration date of payment device 210, etc.), input (e.g., a PIN, a signature, biometric information, etc.), from a cardholder of payment device 210, related to completing and/or authorizing a transaction, and/or the like. In some implementations, example input components of payment device reader 220 may include a number keypad, a touchscreen, a magnetic strip reader, a chip reader, a pen and corresponding signature pad, an RF signal reader, and/or the like.

In some implementations, a magnetic strip reader of payment device reader 220 may receive data from payment device 210 as a magnetic strip of payment device 210 is swiped along the magnetic strip reader. In some implementations, a chip reader of payment device reader 220 may receive data from payment device 210 via an integrated circuit chip (e.g., an EMV chip) of payment device 210 when the chip is placed within communicative proximity of the chip reader. In some implementations, an RF signal reader of payment device reader 220 may enable a contactless transaction from payment device 210 by obtaining data wirelessly from payment device 210 as payment device 210 comes within communicative proximity of payment device reader 220, such that the RF signal reader detects an RF signal from an RF antenna of payment device 210.

In some implementations, example output components of payment device reader 220 may include a display, a speaker, a printer, a light, and/or the like. In some implementations, payment device reader 220 may use an output component to output information related to a transaction (e.g., an indication to cause a user to input information to authorize a transaction, information that identifies whether a transaction was completed, etc.).

Intelligence platform 230 includes one or more devices capable of sending, receiving, generating, storing, processing, and/or providing information associated with intelligently sharing transaction data and/or non-transaction data. For example, intelligence platform 230 may be a platform implemented by cloud computing environment 240 that may, upon receiving a request to share data, determine the relevance of transaction data and/or non-transaction data, and provide the relevant data to a merchant device. In some implementations, intelligence platform 230 is implemented by computing resources 235 of cloud computing environment 240. In some implementations, the intelligence platform may correspond to one merchant (e.g., configured for use by the one merchant), to one financial provider (e.g., configured for use by one financial provider associated with the payment device), or to multiple merchants (e.g., configured for use by the multiple merchants).

While the example environment 200 indicates that intelligence platform 230 is implemented in a cloud computing environment 240, in some implementations, intelligence platform 230 may be implemented by one or more other types of devices as well, such as a server, computer, laptop computer, tablet computer, handheld computer, or the like.

Cloud computing environment 240 includes an environment that delivers computing as a service, whereby shared resources, services, etc. may be provided to intelligently determine, implement, and/or facilitate sharing of transaction data and/or non-transaction data among entities. Cloud computing environment 240 may provide computation, software, data access, storage, and/or other services that do not require end-user knowledge of a physical location and configuration of a system and/or a device that delivers the services. As shown, cloud computing environment 240 may include intelligence platform 230 and computing resource 235.

Computing resource 235 includes one or more personal computers, workstation computers, server devices, or another type of computation and/or communication device. In some implementations, computing resource 235 may host intelligence platform 230. The cloud resources may include compute instances executing in computing resource 235, storage devices provided in computing resource 235, data transfer devices provided by computing resource 235, etc. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, or the like.

Application 235-1 includes one or more software applications that may be provided to or accessed by payment device 210. Application 235-1 may eliminate a need to install and execute the software applications on payment device 210. For example, application 235-1 may include software associated with intelligence platform 230 and/or any other software capable of being provided via cloud computing environment 240. In some implementations, one application 235-1 may send/receive information to/from one or more other applications 235-1, via virtual machine 235-2.

Virtual machine 235-2 includes a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program, and may support a single process. In some implementations, virtual machine 235-2 may execute on behalf of a user (e.g., payment device 210), and may manage infrastructure of cloud computing environment 240, such as data management, synchronization, or long-duration data transfers.

Virtualized storage 235-3 includes one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 provides hardware virtualization techniques that allow multiple operating systems (e.g., “guest operating systems”) to execute concurrently on a host computer, such as computing resource 235. Hypervisor 235-4 may present a virtual operating platform to the guest operating systems, and may manage the execution of the guest operating systems. Multiple instances of a variety of operating systems may share virtualized hardware resources.

Network 250 includes one or more wired and/or wireless networks. For example, network 250 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

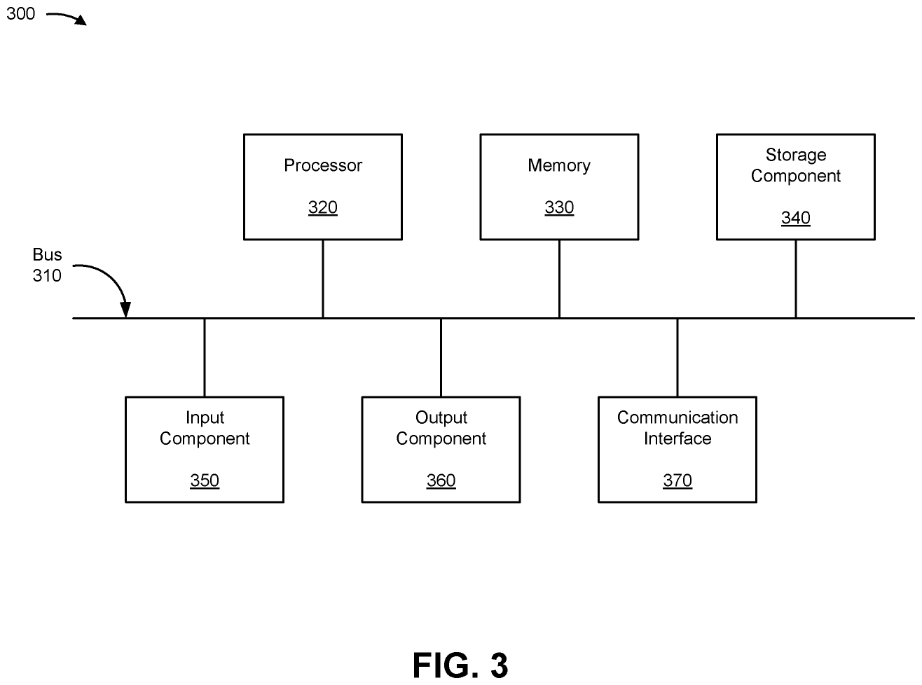

FIG. 3 is a diagram of example components of a device 300. Device 300 may correspond to payment device 210, payment device reader 220, intelligence platform 230, and/or computing resource 235. In some implementations, payment device 210, payment device reader 220, intelligence platform 230, and/or computing resource 235 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

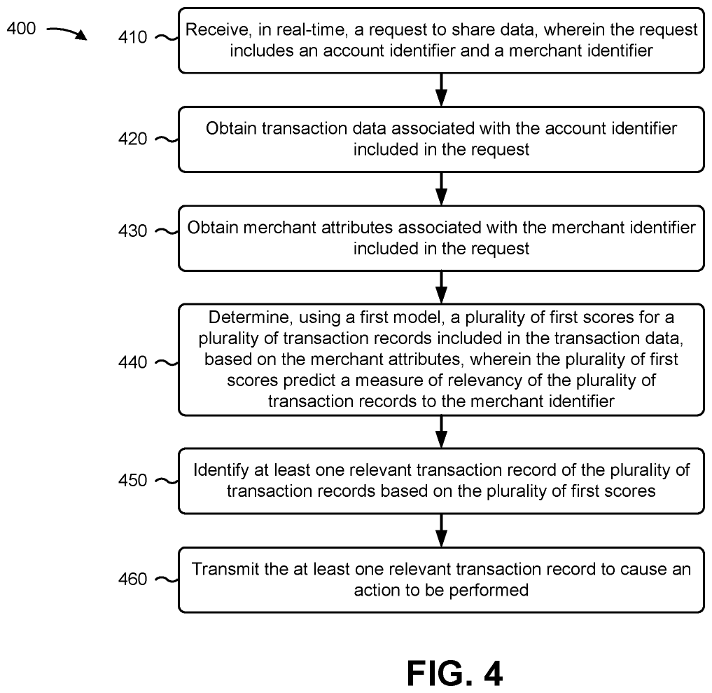

FIG. 4 is a flow chart of an example process 400 for the intelligent sharing of transaction data. In some implementations, one or more process blocks of FIG. 4 may be performed by an intelligence platform (e.g., intelligence platform 230), or a computing resource (e.g., computing resource 235) of the intelligence platform. In some implementations, one or more process blocks of FIG. 4 may be performed by another device or a group of devices separate from or including intelligence platform (e.g., intelligence platform 230), such as a payment device (e.g., payment device 210) or a payment device reader (e.g., payment device reader 220).

As shown in FIG. 4, process 400 may include receiving, in real-time, a request to share data, wherein the request includes an account identifier, and a merchant identifier (block 410). For example, the intelligence platform (e.g., using computing resource 235, processor 320, memory 330, storage component 340, input component 350, communication interface 370, and/or the like) may receive, in real-time, a request to share data, as described above in connection with FIGS. 1A-1C. In some implementations, the request may include an account identifier and a merchant identifier.

As further shown in FIG. 4, process 400 may include obtaining transaction data associated with the account identifier included in the request (block 420). For example, the intelligence platform (e.g., using computing resource 235, processor 320, memory 330, storage component 340, input component 350, communication interface 370, and/or the like) may obtain transaction data associated with the account identifier included in the request, as described above in connection with FIGS. 1A-1C.

As further shown in FIG. 4, process 400 may include obtaining merchant attributes associated with the merchant identifier included in the request (block 430). For example, the intelligence platform (e.g., using computing resource 235, processor 320, memory 330, storage component 340, input component 350, communication interface 370, and/or the like) may obtain merchant attributes associated with the merchant identifier included in the request, as described above in connection with FIGS. 1A-1C.

As further shown in FIG. 4, process 400 may include determining, using a first model, a plurality of first scores for a plurality of transaction records included in the transaction data, based on the merchant attributes, wherein the plurality of first scores predict a measure of relevancy of the plurality of transaction records to the merchant identifier (block 440). For example, the intelligence platform (e.g., using computing resource 235, processor 320, memory 330, storage component 340, and/or the like) may determine, using a first model, a plurality of first scores for a plurality of transaction records included in the transaction data, based on the merchant attributes, as described above in connection with FIGS. 1A-1C. In some implementations, the plurality of first scores may predict a measure of relevancy of the plurality of transaction records to the merchant identifier.

As further shown in FIG. 4, process 400 may include identifying at least one relevant transaction record of the plurality of transaction records based on the plurality of first scores (block 450). For example, the intelligence platform (e.g., using computing resource 235, processor 320, memory 330, storage component 340, and/or the like) may identify at least one relevant transaction record of the plurality of transaction records based on the plurality of first scores, as described above in connection with FIGS. 1A-1C.

As further shown in FIG. 4, process 400 may include transmitting the at least one relevant transaction record to cause an action to be performed (block 460). For example, the intelligence platform (e.g., using computing resource 235, processor 320, memory 330, storage component 340, output component 360, communication interface 370, and/or the like) may transmit the at least one relevant transaction record to cause an action to be performed, as described above in connection with FIGS. 1A-1C.

Process 400 may include additional implementations, such as any single implementation or any combination of implementations described below and/or in connection with one or more other processes described elsewhere herein.

In some implementations, the request to share the data may be initiated by interfacing a payment device with a payment device reader. In some implementations, the at least one relevant transaction record may include one of a record identifying a purchased item, a record identifying a price of a purchased item, a record indicating a size of a purchased item, a record indicating an amount of gratuity associated with a completed transaction, and/or a record indicating an amount of goods purchased from a competitor merchant.

In some implementations, the intelligence platform may obtain non-transaction data associated with the account identifier, where the non-transaction data includes data associated with a user of an account identified by the account identifier or data associated with the account, may determine, using a second model, a plurality of second scores for a plurality of non-transaction records included in the non-transaction data, based on the merchant attributes, where the plurality of second scores predict a second measure of relevancy of the plurality of non-transaction records to the merchant identifier, may identify at least one relevant non-transaction record of the plurality of non-transaction records based on the plurality of second scores, and may transmit the at least one relevant non-transaction record and the at least one relevant transaction record to cause the action to be performed.

In some implementations, the at least one relevant non-transaction record may include a record indicating a personal attribute associated with the user, a record indicating a user preference associated with the user, a record indicating a credit score associated with the user, a record indicating a credit limit associated with the account, a record indicating an amount of available credit associated with the account, a record indicating a tier level associated with the account, a record indicating an available balance associated with the account, or a record indicating an account status associated with the account.

In some implementations, the intelligence platform may identify a plurality of relevant transaction records based on the plurality of first scores, may generate a monetary figure based on information contained in the plurality of relevant transactions records, and may transmit the monetary figure to cause the action to be performed. In some implementations, the intelligence platform may identify a plurality of relevant transaction records based on the plurality of first scores, may obtain merchant preferences associated with the merchant identifier, may identify a subset of the plurality of relevant transaction records based on the merchant preferences, and may transmit the subset of the plurality of relevant transaction records to cause the action to be performed. In some implementations, the intelligence platform may allocate a bonus, a reward, or a discount based on receiving the request to share data, and may provide information indicating the bonus, the reward, or the discount.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

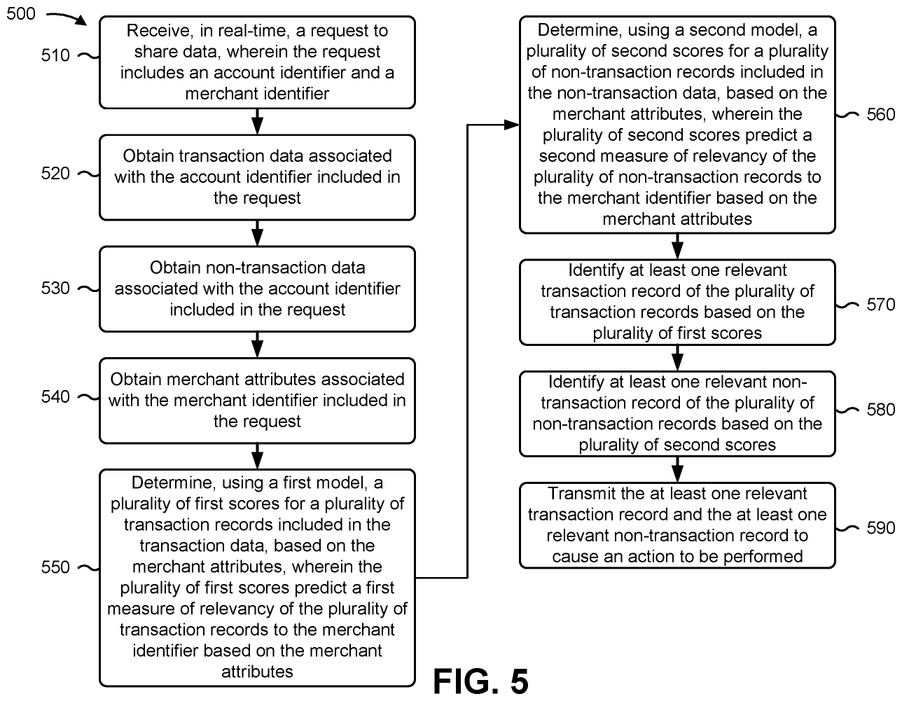

FIG. 5 is a flow chart of an example process 500 for the intelligent sharing of transaction data. In some implementations, one or more process blocks of FIG. 5 may be performed by an intelligence platform (e.g., intelligence platform 230), or a computing resource (e.g., computing resource 235) associated with the intelligence platform. In some implementations, one or more process blocks of FIG. 5 may be performed by another device or a group of devices separate from or including intelligence platform (e.g., intelligence platform 230), such as a payment device (e.g., payment device 210) or a payment device reader (e.g., payment device reader 220).

As shown in FIG. 5, process 500 may include receiving, in real-time, a request to share data, wherein the request includes an account identifier, and a merchant identifier (block 510). For example, the intelligence platform (e.g., using computing resource 235, processor 320, memory 330, storage component 340, input component 350, communication interface 370, and/or the like) may receive, in real-time, a request to share data, as described above in connection with FIGS. 1A-1C. In some implementations, the request may include an account identifier and a merchant identifier.

As further shown in FIG. 5, process 500 may include obtaining transaction data associated with the account identifier included in the request (block 520). For example, the intelligence platform (e.g., using computing resource 235, processor 320, memory 330, storage component 340, input component 350, communication interface 370, and/or the like) may obtain transaction data associated with the account identifier included in the request, as described above in connection with FIGS. 1A-1C.

As further shown in FIG. 5, process 500 may include obtaining non-transaction data associated with the account identifier included in the request (block 530). For example, the intelligence platform (e.g., using computing resource 235, processor 320, memory 330, storage component 340, input component 350, communication interface 370, and/or the like) may obtain non-transaction data associated with the account identifier included in the request, as described above in connection with FIGS. 1A-1C.

As further shown in FIG. 5, process 500 may include obtaining merchant attributes associated with the merchant identifier included in the request (block 540). For example, the intelligence platform (e.g., using computing resource 235, processor 320, memory 330, storage component 340, input component 350, communication interface 370, and/or the like) may obtain merchant attributes associated with the merchant identifier included in the request, as described above in connection with FIGS. 1A-1C.

As further shown in FIG. 5, process 500 may include determining, using a first model, a plurality of first scores for a plurality of transaction records included in the transaction data, based on the merchant attributes, wherein the plurality of first scores predict a first measure of relevancy of the plurality of transaction records to the merchant identifier based on the merchant attributes (block 550). For example, the intelligence platform (e.g., using computing resource 235, processor 320, memory 330, storage component 340, and/or the like) may determine, using a first model, a plurality of first scores for a plurality of transaction records included in the transaction data, based on the merchant attributes, as described above in connection with FIGS. 1A-1C. In some implementations, the plurality of first scores predict a first measure of relevancy of the plurality of transaction records to the merchant identifier based on the merchant attributes.

As further shown in FIG. 5, process 500 may include determining, using a second model, a plurality of second scores for a plurality of non-transaction records included in the non-transaction data, based on the merchant attributes, wherein the plurality of second scores predict a second measure of relevancy of the plurality of non-transaction records to the merchant identifier based on the merchant attributes (block 560). For example, the intelligence platform (e.g., using computing resource 235, processor 320, memory 330, storage component 340, and/or the like) may determine, using a second model, a plurality of second scores for a plurality of non-transaction records included in the non-transaction data, based on the merchant attributes, as described above in connection with FIGS. 1A-1C. In some implementations, the plurality of second scores predict a second measure of relevancy of the plurality of non-transaction records to the merchant identifier based on the merchant attributes.

As further shown in FIG. 5, process 500 may include identifying at least one relevant transaction record of the plurality of transaction records based on the plurality of first scores (block 570). For example, the intelligence platform (e.g., using computing resource 235, processor 320, memory 330, storage component 340, and/or the like) may identify at least one relevant transaction record of the plurality of transaction records based on the plurality of first scores, as described above in connection with FIGS. 1A-1C.

As further shown in FIG. 5, process 500 may include identifying at least one relevant non-transaction record of the plurality of non-transaction records based on the plurality of second scores (block 580). For example, the intelligence platform (e.g., using computing resource 235, processor 320, memory 330, storage component 340, and/or the like) may identify at least one relevant non-transaction record of the plurality of non-transaction records based on the plurality of second scores, as described above in connection with FIGS. 1A-1C.

As further shown in FIG. 5, process 500 may include transmitting the at least one relevant transaction record and the at least one relevant non-transaction record to cause an action to be performed (block 590). For example, the intelligence platform (e.g., using computing resource 235, processor 320, memory 330, storage component 340, input component 350, communication interface 370, and/or the like) may transmit the at least one relevant transaction record and the at least one relevant non-transaction record to cause an action to be performed, as described above in connection with FIGS. 1A-1C.

Process 500 may include additional implementations, such as any single implementation or any combination of implementations described below and/or in connection with one or more other processes described elsewhere herein.

In some implementations, the request may be received from a payment device reader. In some implementations, the request may be generated upon interfacing a payment device with the payment device reader, and the payment device may include a credit card, a debit card, a rewards card, or a mobile device storing a transaction card. In some implementations, the at least one relevant transaction record may include a record identifying a purchased item, a record identifying a price of a purchased item, a record indicating a size of a purchased item, a record indicating an amount of gratuity associated with a completed transaction, or a record indicating an amount of goods purchased from a competitor merchant.

In some implementations, the non-transaction data may include data associated with a user of an account identified by the account identifier, or data associated with the account, and the at least one relevant non-transaction record may include a record indicating a personal attribute associated with the user, a record indicating a user preference associated with the user, a record indicating a credit score associated with the user, a record indicating a credit limit associated with the account, a record indicating an amount of available credit associated with the account, a record indicating a tier level associated with the account, a record indicating an available balance associated with the account, or a record indicating an account status associated with the account.

In some implementations, the personal attribute may include demographic information, a level of income, an allergy, an occupation, a hobby, or a descriptor of at least one family member. In some implementations, the user preference may include a preferred color, a preferred clothing type, a preferred clothing style, a preferred food, a preferred beverage, a preference regarding one or more goods, or a preference regarding one or more services.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

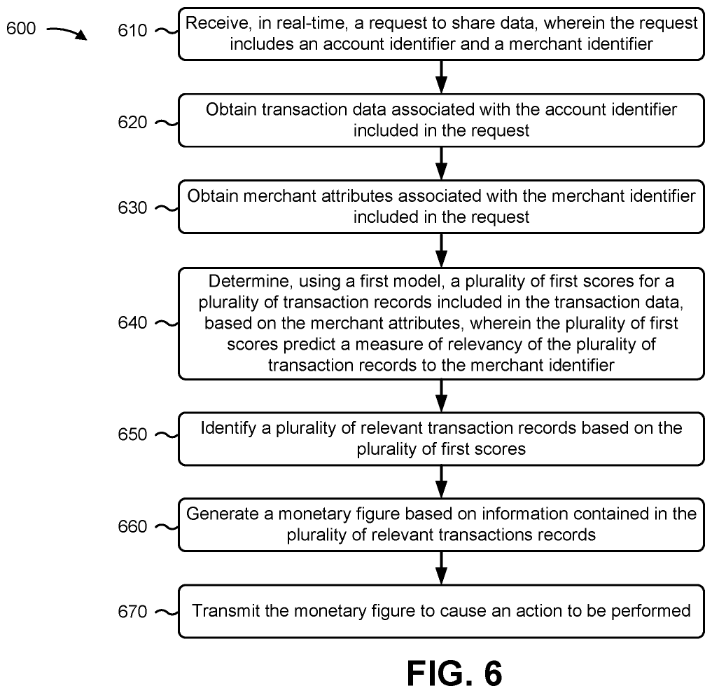

FIG. 6 is a flow chart of an example process 600 for the intelligent sharing of transaction data. In some implementations, one or more process blocks of FIG. 6 may be performed by an intelligence platform (e.g., intelligence platform 230), or a computing resource (e.g., computing resource 235) associated with the intelligence platform. In some implementations, one or more process blocks of FIG. 6 may be performed by another device or a group of devices separate from or including intelligence platform (e.g., intelligence platform 230), such as a payment device (e.g., payment device 210) or a payment device reader (e.g., payment device reader 220).

As shown in FIG. 6, process 600 may include receiving, in real-time, a request to share data, wherein the request includes an account identifier, and a merchant identifier (block 610). For example, the intelligence platform (e.g., using computing resource 235, processor 320, memory 330, storage component 340, input component 350, communication interface 370, and/or the like) may receive, in real-time, a request to share data, as described above in connection with FIGS. 1A-1C. In some implementations, the request may include an account identifier and a merchant identifier.

As further shown in FIG. 6, process 600 may include obtaining transaction data associated with the account identifier included in the request (block 620). For example, the intelligence platform (e.g., using computing resource 235, processor 320, memory 330, storage component 340, input component 350, communication interface 370, and/or the like) may obtain transaction data associated with the account identifier included in the request, as described above in connection with FIGS. 1A-1C.

As further shown in FIG. 6, process 600 may include obtaining merchant attributes associated with the merchant identifier included in the request (block 630). For example, the intelligence platform (e.g., using computing resource 235, processor 320, memory 330, storage component 340, input component 350, communication interface 370, and/or the like) may obtain merchant attributes associated with the merchant identifier included in the request, as described above in connection with FIGS. 1A-1C.

As further shown in FIG. 6, process 600 may include determining, using a first model, a plurality of first scores for a plurality of transaction records included in the transaction data, based on the merchant attributes, wherein the plurality of first scores predict a measure of relevancy of the plurality of transaction records to the merchant identifier (block 640). For example, the intelligence platform (e.g., using computing resource 235, processor 320, memory 330, storage component 340, and/or the like) may determine, using a first model, a plurality of first scores for a plurality of transaction records included in the transaction data, based on the merchant attributes. In some implementations, the plurality of first scores predict a measure of relevancy of the plurality of transaction records to the merchant identifier, as described above in connection with FIGS. 1A-1C.

As further shown in FIG. 6, process 600 may include identifying a plurality of relevant transaction records based on the plurality of first scores (block 650). For example, the intelligence platform (e.g., using computing resource 235, processor 320, memory 330, storage component 340, and/or the like) may identify a plurality of relevant transaction records based on the plurality of first scores, as described above in connection with FIGS. 1A-1C.

As further shown in FIG. 6, process 600 may include generating a monetary figure based on information contained in the plurality of relevant transactions records (block 660). For example, the intelligence platform (e.g., using computing resource 235, processor 320, memory 330, storage component 340, and/or the like) may generate a monetary figure based on information contained in the plurality of relevant transactions records, as described above in connection with FIGS. 1A-1C.

As further shown in FIG. 6, process 600 may include transmitting the monetary figure to cause an action to be performed (block 670). For example, the intelligence platform (e.g., using computing resource 235, processor 320, memory 330, storage component 340, output component 360, communication interface 370, and/or the like) may transmit the monetary figure to cause an action to be performed, as described above in connection with FIGS. 1A-1C.

Process 600 may include additional implementations, such as any single implementation or any combination of implementations described below and/or in connection with one or more other processes described elsewhere herein.

In some implementations, the monetary figure may be transmitted to a payment device reader. In some implementations, the intelligence platform may obtain non-transaction data associated with the account identifier, where the non-transaction data includes data associated with a user of an account identified by the account identifier or data associated with the account, may determine, using a second model, a plurality of second scores for a plurality of non-transaction records included in the non-transaction data, based on the merchant attributes, where the plurality of second scores predict a measure of relevancy of the plurality of non-transaction records to the merchant identifier, may identify at least one relevant non-transaction record of the plurality of non-transaction records based on the plurality of second scores, and may transmit the at least one relevant non-transaction record to cause the action to be performed.

In some implementations, the intelligence platform may obtain merchant preferences associated with the merchant identifier, may identify a subset of the plurality of relevant transaction records based on the merchant preferences, and may transmit the subset of the plurality of relevant transaction records to cause the action to be performed. In some implementations, the intelligence platform may allocate a bonus, a reward, or a discount based on receiving the request to share data, and may provide information indicating the bonus, the reward, or the discount.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Some implementations described herein provide an intelligence platform 230, by which a user may opt-in to share data (e.g., transaction data, non-transaction data, etc.) with a merchant during an in-person visit to the merchant's business, to improve the user's in-person retail experience. The user may opt-in to sharing such data using a respective payment device 210, such as an NFC-enabled payment device, a payment card, and/or the like. The intelligence platform 230 may obtain the data associated with the user, and intelligently determine which data records included in the data may be relevant to the merchant, for sharing with the merchant to improve the user's in-person visit.

For example, the intelligence platform 230 may employ a model to determine a plurality of scores for a plurality of transaction records included in transaction data associated with a user, and identify relevant transaction records to share with the merchant, based on the scores. The scores may predict a measure of relevancy of the plurality of transaction records to the merchant identifier. The merchant may obtain the relevant transaction records and tailor the user's experience during the user's in-person visit, for example, by presenting specific goods to the user, by offering the user a reward, by increasing a level of service provided to the user, and/or the like. In this way, the intelligence platform 230 may automate the generation and/or transmission of relevant data to the merchant, thus, conserving resources that would otherwise be needed to manually generate such relevant data. In this way, the provision of relevant data to the merchant may be more automated, efficient, and meaningful.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
receiving, by a processor and in real-time, a request to share data,
wherein the request includes:
an account identifier, and
a merchant identifier, and
wherein the request corresponds to a particular transaction;
obtaining, by the processor, transaction data associated with the account identifier included in the request,
the transaction data including a plurality of transaction records,
each transaction record, of the plurality of transaction records, including transaction metadata for a respective transaction associated with the account identifier;
obtaining, by the processor, merchant attributes corresponding to a merchant identified by the merchant identifier included in the request,
the merchant attributes identifying at least one competitor of the merchant;
determining, by the processor, and, using a first model, a plurality of first scores for the plurality of transaction records included in the transaction data, based on the merchant attributes,
wherein the plurality of first scores predict a measure of relevancy of the plurality of transaction records to the merchant identifier,
wherein the first model is a machine learning model trained to:
receive, as input, the merchant attributes and at least a portion of the transaction metadata,
the at least the portion of the transaction metadata including information identifying a particular competitor, of the at least one competitor of the merchant, and
produce, as output, the plurality of first scores, and
wherein a particular first score, of the plurality of first scores, for a particular transaction record, of the plurality of transaction records, is based on the information identifying the particular competitor;
identifying, by the processor, a plurality of relevant transaction records of the plurality of transaction records based on the plurality of first scores,
the plurality of relevant transaction records including the particular transaction record;
generating, by the processor, a data representing a monetary amount based on information contained in the particular transaction record; and
transmitting, by the processor, the data representing the monetary amount to cause an action to be performed with respect to the particular transaction.

2. The method of claim 1, wherein the request to share the data is initiated by interfacing a payment device with a payment device reader.

3. The method of claim 1, wherein the plurality of relevant transaction records includes at least one of:
a record identifying a purchased item,
a record identifying a price of a purchased item,
a record indicating a size of a purchased item,
a record indicating an amount of gratuity associated with a completed transaction, or
a record indicating an amount of goods purchased from the particular competitor.

4. The method of claim 1, further comprising:
obtaining non-transaction data associated with the account identifier,
wherein the non-transaction data includes:
data associated with a user of an account identified by the account identifier, or
data associated with the account;
determining, using a second model, a plurality of second scores for a plurality of non-transaction records included in the non-transaction data, based on the merchant attributes,
wherein the plurality of second scores predict a measure of relevancy of the plurality of non-transaction records to the merchant identifier;
identifying at least one relevant non-transaction record of the plurality of non-transaction records based on the plurality of second scores; and
transmitting the at least one relevant non-transaction record to cause the action to be performed.

5. The method of claim 4, wherein the at least one relevant non-transaction record includes one of:
a record indicating a personal attribute associated with the user,
a record indicating a user preference associated with the user,
a record indicating a credit score associated with the user,
a record indicating a credit limit associated with the account,
a record indicating an amount of available credit associated with the account,
a record indicating a tier level associated with the account,
a record indicating an available balance associated with the account, or
a record indicating an account status associated with the account.

6. (canceled)

7. The method of claim 1, further comprising:
obtaining merchant preferences associated with the merchant identifier;
identifying a subset of the plurality of relevant transaction records based on the merchant preferences; and
transmitting the subset of the plurality of relevant transaction records to cause the action to be performed.

8. The method of claim 1, further comprising:
allocating a bonus, a reward, or a discount based on receiving the request to share data; and
providing information indicating the bonus, the reward, or the discount.

9. A device, comprising:
one or more memories; and
one or more processors, communicatively coupled to the one or more memories, to:
receive, in real-time, a request to share data,
wherein the request includes:
an account identifier, and
a merchant identifier, and
wherein the request corresponds to a particular transaction;
obtain transaction data associated with the account identifier included in the request,
the transaction data including a plurality of transaction records,
each transaction record, of the plurality of transaction records, including transaction metadata for a respective transaction associated with the account identifier;
obtain non-transaction data associated with the account identifier included in the request;
obtain merchant attributes corresponding to a merchant identified by the merchant identifier included in the request,
the merchant attributes identifying at least one competitor of the merchant;
determine, using a first model, a plurality of first scores for the plurality of transaction records included in the transaction data, based on the merchant attributes,
wherein the plurality of first scores predict a first measure of relevancy of the plurality of transaction records to the merchant identifier based on the merchant attributes,
wherein the first model is a machine learning model trained to:
receive, as input, the merchant attributes and at least a portion of the transaction metadata,
the at least the portion of the transaction metadata including information identifying a particular competitor, of the at least one competitor of the merchant, and
produce, as output, the plurality of first scores, and
wherein a particular first score, of the plurality of first scores, for a particular transaction record, of the plurality of transaction records, is based on the information identifying the particular competitor;
determine, using a second model, a plurality of second scores for a plurality of non-transaction records included in the non-transaction data, based on the merchant attributes,
wherein the plurality of second scores predict a second measure of relevancy of the plurality of non-transaction records to the merchant identifier based on the merchant attributes;
identify a plurality of relevant transaction records of the plurality of transaction records based on the plurality of first scores,
the plurality of relevant transaction records including the particular transaction record;
identify at least one relevant non-transaction record of the plurality of non-transaction records based on the plurality of second scores;
generate data representing a monetary amount based on information contained in the particular transaction record and the at least one relevant non-transaction record; and
transmit the data representing the monetary amount to cause an action to be performed with respect to the particular transaction.

10. The device of claim 9, wherein the request is received from a payment device reader.

11. The device of claim 10, wherein the request is generated upon interfacing a payment device with the payment device reader, and
wherein the payment device includes one of:
a credit card,
a debit card,
a rewards card, or
a mobile device storing a transaction card.

12. The device of claim 9, wherein the plurality of relevant transaction records includes at least one of:
a record identifying a purchased item,
a record identifying a price of a purchased item,
a record indicating a size of a purchased item,
a record indicating an amount of gratuity associated with a completed transaction, or
a record indicating an amount of goods purchased from the particular competitor.

13. The device of claim 9, wherein the non-transaction data includes:
data associated with a user of an account identified by the account identifier, or
data associated with the account, and
wherein the at least one relevant non-transaction record includes one of:
a record indicating a personal attribute associated with the user,
a record indicating a user preference associated with the user,
a record indicating a credit score associated with the user,
a record indicating a credit limit associated with the account,
a record indicating an amount of available credit associated with the account,
a record indicating a tier level associated with the account,
a record indicating an available balance associated with the account, or
a record indicating an account status associated with the account.

14. The device of claim 13, wherein the personal attribute includes one of:
demographic information,
a level of income,
an allergy,
an occupation,
a hobby, or
a descriptor of at least one family member.

15. The device of claim 13, wherein the user preference includes one of:
a preferred color,
a preferred clothing type,
a preferred clothing style,
a preferred food,
a preferred beverage,
a preference regarding one or more goods, or
a preference regarding one or more services.

16. A non-transitory computer-readable medium storing instructions, the instructions comprising:
one or more instructions that, when executed by one or more processors, cause the one or more processors to:
receive, in real-time, a request to share data,
wherein the request includes:
an account identifier, and
a merchant identifier, and
wherein the request corresponds to a particular transaction;
obtain transaction data associated with the account identifier included in the request,
the transaction data including a plurality of transaction records,
each transaction record, of the plurality of transaction records, including transaction metadata for a respective transaction associated with the account identifier;
obtain merchant attributes corresponding to a merchant identified by the merchant identifier included in the request,
the merchant attributes identifying at least one competitor of the merchant;
determine, using a first model, a plurality of first scores for a plurality of transaction records included in the transaction data, based on the merchant attributes,
wherein the plurality of first scores predict a measure of relevancy of the plurality of transaction records to the merchant identifier,
wherein the first model is a machine learning model trained to:
receive, as input, the merchant attributes and at least a portion of the transaction metadata,
the at least the portion of the transaction metadata including information identifying a particular competitor, of the at least one competitor of the merchant, and
produce, as output, the plurality of first scores, and
wherein a particular first score, of the plurality of first scores, for a particular transaction record, of the plurality of transaction records, is based on
the information identifying the particular competitor;
identify a plurality of relevant transaction records, of the plurality of transaction records, based on the plurality of first scores,
the plurality of relevant transaction records including the particular transaction record;
generate data representing a monetary amount based on information contained in the particular transaction record; and
transmit the data representing the monetary amount to cause an action to be performed with respect to the particular transaction.

17. The non-transitory computer-readable medium of claim 16, wherein the data representing the monetary amount is transmitted to a payment device reader.

18. The non-transitory computer-readable medium of claim 16, wherein the one or more instructions, when executed by the one or more processors, further cause the one or more processors to:
obtain non-transaction data associated with the account identifier,
wherein the non-transaction data includes:
data associated with a user of an account identified by the account identifier, or
data associated with the account;
determine, using a second model, a plurality of second scores for a plurality of non-transaction records included in the non-transaction data, based on the merchant attributes,
wherein the plurality of second scores predict a measure of relevancy of the plurality of non-transaction records to the merchant identifier;
identify at least one relevant non-transaction record of the plurality of non-transaction records based on the plurality of second scores; and
transmit the at least one relevant non-transaction record to cause the action to be performed.

19. The non-transitory computer-readable medium of claim 16, wherein the one or more instructions, when executed by the one or more processors, further cause the one or more processors to:
obtain merchant preferences associated with the merchant identifier;
identify a subset of the plurality of relevant transaction records based on the merchant preferences; and
transmit the subset of the plurality of relevant transaction records to cause the action to be performed.

20. The non-transitory computer-readable medium of claim 16, wherein the one or more instructions, when executed by the one or more processors, further cause the one or more processors to:
allocate a bonus, a reward, or a discount based on receiving the request to share data; and
provide information indicating the bonus, the reward, or the discount.

21. The method of claim 1, wherein the action to be performed with respect to the particular transaction includes applying a discount to the particular transaction based on the data representing the monetary amount.
